(19) United States
(12) Patent Application Publication
(10) Pub. No.: US 2023/0274093 A1
(43) Pub. Date: Aug. 31, 2023

(54) METHOD AND SYSTEM FOR PERFORMANCE EVALUATION USING AN AI MODEL

(71) Applicant: INFOSYS LIMITED, Bangalore (IN)

(72) Inventors: Amit KUMAR, Hyderabad (IN); Venugopal SUBARAO, Bengaluru (IN); Kolichina Ravi KIRAN, Hyderabad (IN); Vishal MANCHANDA, Punjab (IN); Anand SANTHANAM, London (GB)

(21) Appl. No.: 17/698,707

(22) Filed: Mar. 18, 2022

(30) Foreign Application Priority Data
Feb. 28, 2022 (IN) 202241010779

(51) Int. Cl. G06F 40/40; G06N 5/02; G06N 5/04; G06F 40/205; G06F 40/284

(52) U.S. Cl. CPC G06F 40/40; G06N 5/022; G06N 5/04; G06F 40/205; G06F 40/284

(57) ABSTRACT

Provided is a method and system for performance evaluation using an AI model comprising automatic extraction of accurate call disposition details from the interactions for any domain, so that interactions can be tagged consistently and accurately, and actionable insights can be derived, by training AI models. It provides a method and system that can be used in real time for automating the call disposition detailing for any conversation over a call. In an example the call conversation may be a customer care call, or any other work-related call. It may allow users to extract issues, cause and resolution from a call transcript with utmost accuracy, also train it further on client specific data. The extracted text is then used to for performance evaluation using multiple KPIs and parameters.

This application claims the benefit of Indian Patent Application No. 202241010779, filed 28 Feb. 2022, which is incorporated by reference in its entirety.

### FIELD

This technology generally relates to an AI assisted method and system for performance evaluation. More particularly examples of this technology relate to text disposition for performance evaluation.

### BACKGROUND

In most domains, the process of extracting the disposition details from an interaction is either missing or manual. It is time consuming and inaccurate due to time constraint, inadequate checks, lack of automation etc. There are no trained disposition models available.

### SUMMARY

Provided is an example of a method for performance evaluation using a language model which comprises training one or more data generation AI model and generating a training data for each of one or more requirements, using the trained AI data generation model and a set of predetermined parameters. Unsupervised training is performed of one or more language model for a predecided domain, using the generated training data, followed by extracting one or more details from a transcript text of a call participant using the trained language model; and evaluating the performance of the participant using the extracted details and the set of predetermined parameters.

Provided is an example of a system for performance evaluation using a language model which comprises a training engine for training one or more data generation AI model and generating a training data for each of one or more requirements, using the trained AI data generation model and a set of predetermined parameters. Unsupervised training is performed of one or more language model for a predecided domain, using the generated training data, followed by extracting one or more details from a transcript text of a call participant using the trained language model; and evaluating the performance of the participant using the extracted details and the set of predetermined parameters using an inference engine.

Provided is an example of a non-transitory computer readable medium having stored thereon instructions comprising executable code which when executed by one or more processors, causes the processors to train one or more data generation AI model and generate a training data for each of one or more requirements, using the trained AI data generation model and a set of predetermined parameters. Unsupervised training is performed of one or more language model for a predecided domain, using the generated training data, followed by extracting one or more details from a transcript text of a call participant using the trained language model; and evaluating the performance of the participant using the extracted details and the set of predetermined parameters.

### BRIEF DESCRIPTION OF DRAWINGS

FIG. 1 relates to a general-purpose computing system to implement an example of the process as disclosed;

FIG. 2 relates to a flowchart relating to an example of the process as disclosed; and

FIG. 3 relates to an example of the architecture overview to implement the process as disclosed.

### DETAILED DESCRIPTION

An example of the present disclosure provides automatic extraction of accurate call disposition details from the interactions for any domain, so that interactions can be tagged consistently and accurately, and actionable insights can be derived. It provides a method and system that can be used in real time for automating the call disposition detailing for any conversation over a call. In an example the call conversation may be a customer care call, or any other work-related call. It may allow users to extract issues, cause and resolution from a call transcript with utmost accuracy, also train it further on client specific data. The extracted text is then used to for performance evaluation using multiple KPIs and parameters.

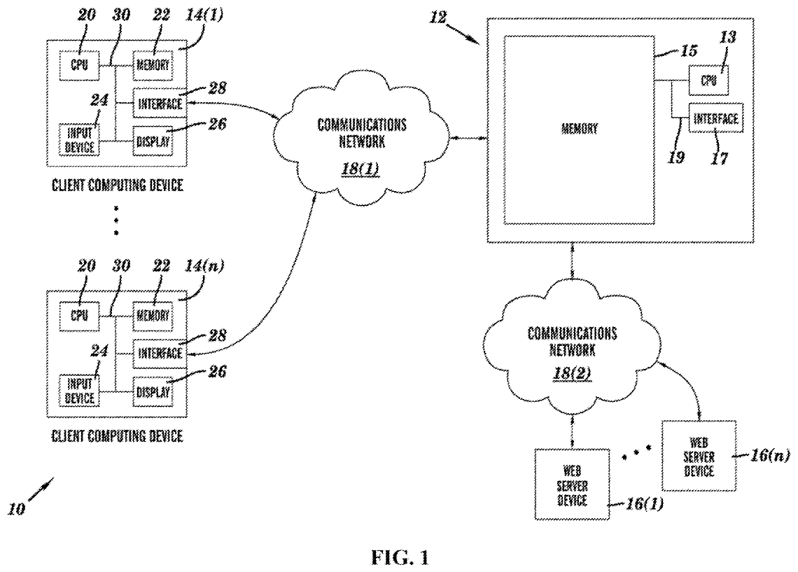

An exemplary environment 10 with a performance evaluation system 12 configured to extract and process information, is illustrated in FIG. 1, although this technology can be implemented on other types of devices, such as one of the web server devices 16(1)-16(n), or any other server computing apparatus configured to receive and process hypertext transfer protocol (HTTP) requests, by way of example only. The exemplary environment 10 includes an knowledge processing system 12, client devices 14(1)-14(n), the web server devices 16(1)-16(n), and communication networks 18(1)-18(2), although other numbers and types of systems, devices, and/or elements in other configurations and environments with other communication network topologies can be used. This technology provides several advantages including providing a method, computer readable medium and an apparatus that can provide knowledge processing system.

Referring more specifically to FIG. 1, the knowledge processing system 12 may include a central processing unit (CPU) or processor 13, a memory 15, and an interface system 17 which are coupled together by a bus 19 or other link, although other numbers and types of components, parts, devices, systems, and elements in other configurations and locations can be used. The processor 13 in the knowledge processing system 12 executes a program of stored instructions for one or more aspects of the present disclosure as described and illustrated by way of the examples herein, although the processor could execute other numbers and types of programmed instructions.

The memory 15 in the knowledge processing system 12 stores these programmed instructions for one or more aspects of the present invention as described and illustrated herein, although some or all of the programmed instructions could be stored and/or executed elsewhere. A variety of different types of memory storage devices, such as a random access memory (RAM) or a read only memory (ROM) in the system or a floppy disk, hard disk, CD ROM, DVD ROM, or other computer readable medium which is read from and/or written to by a magnetic, optical, or other reading and/or writing system that is coupled to the processor 13, can be used for the memory 15 in the web content optimization computing apparatus 12.

The interface system 17 in the knowledge processing system 12 is used to operatively couple and communicate between the knowledge processing system 12 and the client devices 14(1)-14(n) and the web server devices 16(1)-16(n) via the communication networks 18(1) and 18(2), although other types and numbers of communication networks with other types and numbers of connections and configurations can be used. By way of example only, the communication networks 18(1) and 18(2) can use TCP/IP over Ethernet and industry-standard protocols, including HTTP, HTTPS, WAP, and SOAP, although other types and numbers of communication networks, such as a direct connection, a local area network, a wide area network, modems and phone lines, e-mail, and wireless and hardwire communication technology, each having their own communications protocols, can be used.

Each of the client devices 14(1)-14(n) enables a user to request, receive, and interact with web pages from one or more web sites hosted by the web server devices 16(1)-16(n) through the knowledge processing system 12 via one or more communication networks 18(1). Although multiple client devices 14(1)-14(n) are shown, other numbers and types of user computing systems could be used. In one example, the client devices 14(1)-14(n) comprise smart phones, personal digital assistants, computers, or mobile devices with Internet access that permit a website form page or other retrieved web content to be displayed on the client devices 14(1)-14(n).

Each of the client devices 14(1)-14(n) in this example is a computing device that includes a central processing unit (CPU) or processor 20, a memory 22, user input device 24, a display 26, and an interface system 28, which are coupled together by a bus 30 or other link, although one or more of the client devices 14(1)-14(n) can include other numbers and types of components, parts, devices, systems, and elements in other configurations. The processor 20 in each of the client devices 14(1)-14(n) executes a program of stored instructions for one or more aspects of the present invention as described and illustrated herein, although the processor could execute other numbers and types of programmed instructions.

The memory 22 in each of the client devices 14(1)-14(n) stores these programmed instructions for one or more aspects of the present invention as described and illustrated herein, although some or all of the programmed instructions could be stored and/or executed elsewhere. A variety of different types of memory storage devices, such as a random access memory (RAM) or a read only memory (ROM) in the system or a floppy disk, hard disk, CD ROM, or other computer readable medium which is read from and/or written to by a magnetic, optical, or other reading and/or writing system that is coupled to processor 20 can be used for the memory 22 in each of the client devices 14(1)-14(n).

The user input device 24 in each of the client devices 14(1)-14(n) is used to input selections, such as requests for a particular website form page or to enter data in fields of a form page, although the user input device could be used to input other types of data and interact with other elements. The user input device can include keypads, touch screens, and/or vocal input processing systems, although other types and numbers of user input devices can be used.

The display 26 in each of the client devices 14(1)-14(n) is used to show data and information to the user, such as website or application page by way of example only. The display in each of the client devices 14(1)-14(n) can be a mobile phone screen display, although other types and numbers of displays could be used depending on the particular type of client device 14(1)-14(n).

The interface system 28 in each of the client devices 14(1)-14(n) is used to operatively couple and communicate between the client devices 14(1)-14(n), the knowledge processing system 12, and the web server devices 16(1)-16(n) over the communication networks 18(1) and 18(2), although other types and numbers of communication networks with other types and numbers of connections and configurations can be used.

The web server devices 16(1)-16(n) provide web content such as one or more pages from one or more web sites for use by one or more of the client devices 14(1)-14(n) via the web content optimization computing apparatus 12, although the web server devices 16(1)-16(n) can provide other numbers and types of applications and/or content and can provide other numbers and types of functions. Although the web server devices 16(1)-16(n) are shown for ease of illustration and discussion, other numbers and types of web server systems and devices can be used.

Each of the web server devices 16(1)-16(n) include a central processing unit (CPU) or processor, a memory, and an interface system which are coupled together by a bus or other link, although each of the web server devices 16(1)-16(n) could have other numbers and types of components, parts, devices, systems, and elements in other configurations and locations. The processor in each of the web server devices 16(1)-16(n) executes a program of stored instructions one or more aspects of the present invention as described and illustrated by way of the examples herein, although the processor could execute other numbers and types of programmed instructions.

The memory in each of the web server devices 16(1)-16(n) stores these programmed instructions for one or more aspects of the present invention as described and illustrated by way of the examples described and illustrated herein, although some or all of the programmed instructions could be stored and/or executed elsewhere. A variety of different types of memory storage devices, such as a random access memory (RAM) or a read only memory (ROM) in the system or a floppy disk, hard disk, CD ROM, DVD ROM, or other computer readable medium which is read from and/or written to by a magnetic, optical, or other reading and/or writing system that is coupled to the processor, can be used for the memory in each of the web server devices 16(1)-16(n).

The interface system in each of the web server devices 16(1)-16(n) is used to operatively couple and communicate between the web server devices 16(1)-16(n), the knowledge processing system 12, and the client devices 14(1)-14(n) via the communication networks 18(1) and 18(2), although other types and numbers of communication networks with other types and numbers of connections and configurations can be used.

Although examples of the knowledge processing system 12, the client devices 14(1)-14(n), and the web server devices 16(1)-16(n), are described and illustrated herein, each of the client devices 14(1)-14(n), the knowledge processing system 12, and the web server devices 16(1)-16(n), can be implemented on any suitable computer system or computing device. It is to be understood that the devices and systems of the examples described herein are for exemplary purposes, as many variations of the specific hardware and software used to implement the examples are possible, as will be appreciated by those skilled in the relevant art(s).

Furthermore, each of the systems of the examples may be conveniently implemented using one or more general purpose computer systems, microprocessors, digital signal processors, and micro-controllers, programmed according to the teachings of the examples, as described and illustrated herein, and as will be appreciated by those ordinary skill in the art.

In addition, two or more computing systems or devices can be substituted for any one of the systems in any of the examples. Accordingly, principles and advantages of distributed processing, such as redundancy and replication also can be implemented, as desired, to increase the robustness and performance of the devices and systems of the examples. The examples may also be implemented on computer system or systems that extend across any suitable network using any suitable interface mechanisms and communications technologies, including by way of example only telecommunications in any suitable form (e.g., voice and modem), wireless communications media, wireless communications networks, cellular communications networks, G3 communications networks, Public Switched Telephone Network (PSTNs), Packet Data Networks (PDNs), the Internet, intranets, and combinations thereof

The examples may also be embodied as a non-transitory computer readable medium having instructions stored thereon for one or more aspects of the present invention as described and illustrated by way of the examples herein, as described herein, which when executed by a processor, cause the processor to carry out the steps necessary to implement the methods of the examples, as described and illustrated herein.

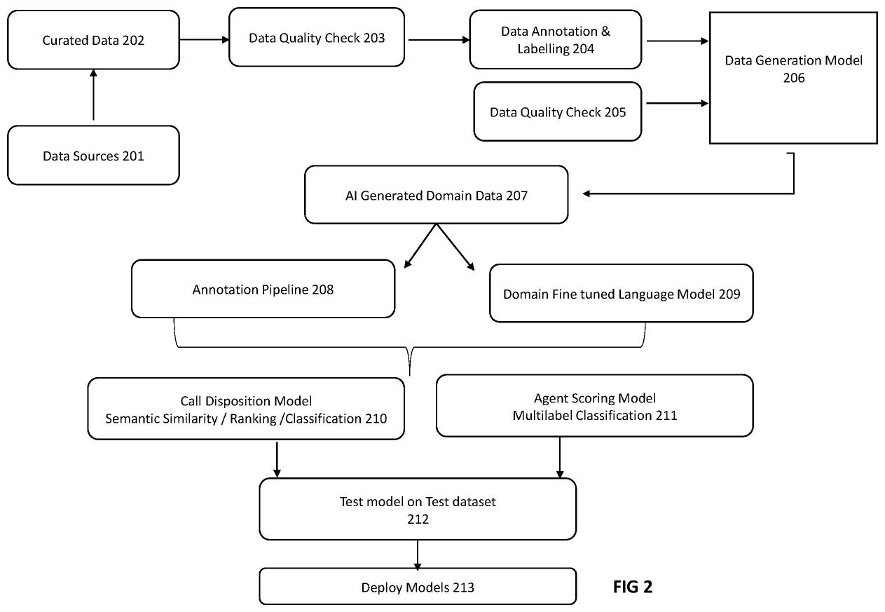

An example of the process to implement the present disclosure will now be explained using FIG. 2. In an example, the present process may be implemented for specific domains. It discloses providing a training data. The training data maybe a dataset from the required domain. In one example, initially a SME or any other person can create and provide training data for the required domain (201). This training data can be processed as appropriate before being finalized (202). In one example it can be reviewed continuously till it may meet some pre-decided requirements (203). In one example, data templates can be used along with subject matter expert inputs for creating data set.

In another example, a domain data creation model may be used alternatively for generating the training data. The domain data creation model may be a ML based model. The trained ML domain data generation model may then be used to generate domain-specific more realistic data. In one example, grammar correction AI model for better quality domain data generation may be used. In another example informal or formal conversations, paraphrasing, active to passive and other different techniques for domain data augmentation may be used for data creation. Accordingly, the model (206) may be trained for generating required data (205)

In an example, the data generation AI model for a specific required domain can be used. For instance, if a user in the telecom industry uses the present technology, a telecom data generation model can be trained appropriately and then tuned for the proper requirements.

The generated training data maybe annotated with one or more predefined labels (204). Data labelling may be completely focused on creating good data rather having big or huge data. In an example it includes label consistency such that whenever there is disagreement, a pipeline may make sure the analysis of the definition of input x and output y and its coverage. In an example, the whole labelling at the end may go through multiple processing including voting, reviewing, and building consensus. In an example label consistency may be maintained. There may be a pipeline (208) which may make sure the definition of input x and output y and its coverage is used.

In an example, only a predecided portion of the training data may be labelled. The user may decide the required portion of the training data to be labelled based on the requirements or the environment or any other related parameter.

In an example, once the training data is generated (207) using the trained data generation AI model, a language model is trained using the training data (209). In an example, unsupervised training may be used for the language models. Unsupervised learning may provide an advantage of better understanding of the domain literature. Appropriate raw data from data sources may be used for the unsupervised learning. In an example supervised learning maybe done for the language models using the labelled data

In an example, for unsupervised learning the language model may be parsed. This may enable appropriate training of the training model using raw domain data.

In an example, a further training of the language model may be needed for another or second level domain training as appropriate

Any existing language model may be used and trained further for the present requirements. In an example, BERT language model may be used. In an example, for training the language model following process may be used as described below.

Any personal information may be removed and text maybe normalized. For each transcript, CLS and SEP token maybe added. Ex: “[CLS]”+transcript +“[SEP]”.

Text maybe made case sensitive and tokenized. The tokens maybe randomly replaced with MASK token. The model is fine-tuned and loaded. Alternatively, a language model is created by initialing the weights with pretrained model weights.

Loss per calculation maybe calculated by various loss functions. Using loss, gradients may be calculated with respect to all trainable parameters.

Using the calculated gradients, the weights maybe updated by adding to it using an optimizer. The updated weights and graphs, and the trained weights and graph maybe saved for later use. In one example the above process enables unsupervised training of language models.

In an example the trained data generation AI model is used to generate training data for the context as needed by a user. In one example the training data generated can be related to issue-cause resolution. Alternatively the training data can be a specific conversation generation. The training data may also be a task specific conversation (210, 211). Accordingly a user can train the data generation AI model as per the context or the requirements. The requirements for the data generation are not limited and can vary as per the requirements of the user. The language model may then be trained and tuned according to the training data generated by the data generation AI model.

The requirements based data generation can be done using tokenizing, calculating loss, backward pass, forward pass and other processes related to any AI models. The weights can be adjusted as per the requirements. For instance, for domain specific training of AI model, the weights can be initialized with pretrained Domain specific model weights. The labeling and tokenizing of the data may also be configured as per the requirements.

In an example, once the AI data generation model and language model have been appropriately processed, they can be used for further requirements. In one example, the trained and tuned language models may be used for evaluation of a caller or an agent participating in a call. A call disposition data may be used after a call to evaluate a participant of the call (210/211).

For instance, in one example, customer care call agents can be evaluated using a call disposition data, for a call they may have with a user. Similarly any call log, any other log data or text can be evaluated using the trained language model.

The AI models as trained above may be tested and evaluated on a test dataset (212). The dataset generated above, may be used for learning and testing as appropriate. In an example 80% data may be used for learning and 20% data may be used for testing. The models can then be deployed for live implementation (213).

For the purpose of explanation, in this document, we will consider the evaluation of a customer service agent, using the language model. In an example, a user may decide some parameters for the evaluation. In an example, for the evaluation a user may use the below parameters. These parameters can be modified as per the requirements, domain along with other factors. This may not be an exhaustive list, and a user may add or remove parameters as appropriate and use the parameters following the process as explained in the present disclosure.

In an example, a participant in a call may be evaluated for Professional behavior. Professional behavior may include evaluation based on politeness; professionalism and, rapport through personalization, empathy. The AI models discussed above maybe appropriately trained for this evaluation.

In an example, a participant in a call may be evaluated for Discover. It may include capability to understand the issues faced by a caller. It may include parameters such as Listening; Repeating the discussed issues; Using system insights; Asking Open Ended questions and, Probing Questions and Closed Questions. The AI models discussed above maybe appropriately trained for this evaluation.

In an example, a participant in a call may be evaluated for Recommendation. It may include Recommending a solution reasonably aligned with the customer's needs based on discovery as discussed in previous paragraph. The AI models discussed above maybe appropriately trained for this evaluation.

In an example, a participant in a call may be evaluated for Overcoming all objections. It may include Brand value statement; comparison statement; clarification statement; and reassurance statement. The AI models discussed above maybe appropriately trained for this evaluation.

In an example, a participant in a call may be evaluated for Closure. It may include Recap solution, asked if additional issues; and thanking the caller.

In an example, the call participant is ranked or evaluated on the above parameters using the AI model. The AI model may be trained to intelligently learn and evaluate the agent.

In one example, the data generation AI model can be configured to generate test data for each of the listed parameters. The language model can be trained for each of the generated data, which can be used over the call log, or the call disposition, or in any other requirement for evaluation.

For each of these parameters, the call log maybe analyzed and a score maybe generated for the customer agent.

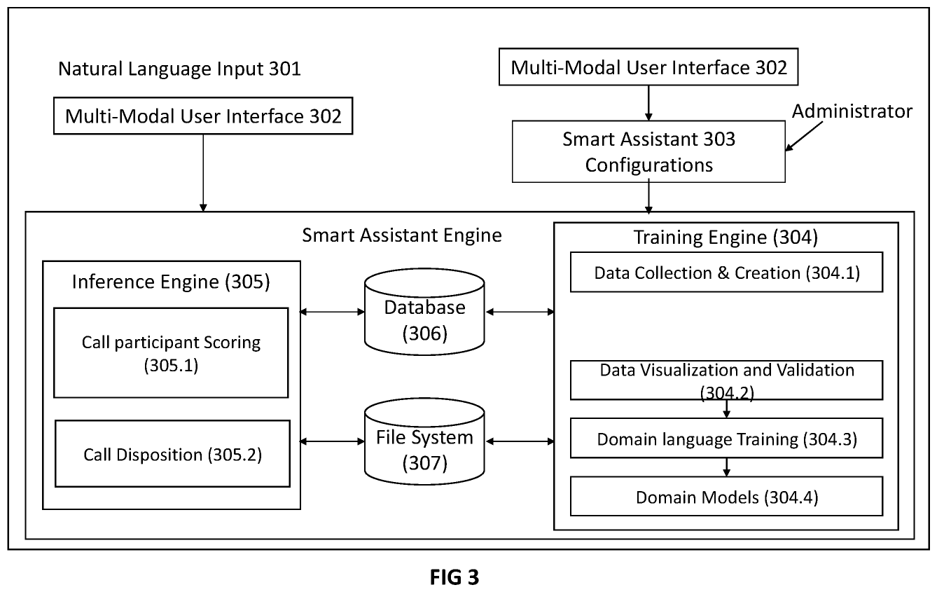

An example of the computing architecture to implement the present process will now be explained using FIG. 3. In an example a natural language input (301) may be provided. In an example, this may be a file a from call recording. This input may be provided to a user interface (302) which may be configured to handle and process natural language input in audio, video or textual format. It may be a multi modal or a micro frontend which adjust itself based on screen size and dimension of the devices. Its independent module and can run on web, mobile etc.

In one example, a Smart Assistant Configurator 303 may be provided for admin to enable configuring various consumer agent interaction and take action and insight based on certain input. It may help admin to filter agent performance based on various parameters.

In an example, the architecture may include a training engine (304). In an example, the training engine may include various components configured and integrated through various appropriate means to implement the process as explained earlier.

In an example, the training engine may include a Data collection and Creation component (304.1). This may include data generation AI model which may be trained as explained earlier. This may also receive input from the user interface (302) as well to generate datasets for training. It may be configured to get initial input training data. The initial data may be provided by an SME or can be provided by any other system. The data collection and creation component may include a data creation AI model that can be trained using the initial data. The AI model can then be tuned to generate the required data. The required data may be specific to a domain, or specific to user, or specific to a task or any other way the user wants.

In an example a data visualization and validation component (304.2) may annotate, label and tune data in a better way. A proper data quality check guidelines maybe based on one or more of—open source licenses and copyright for instance FOSS check, Internal tools etc.; High predictability data signals analysis; Data coverage from different context & diversity; Data consistency and its types; Data outlier's detection and other such appropriate parameters as per user requirements.

This data may be then be transferred to a Domain model (304.4) which may be used for training the language models for a particular domain. This component may help train a language model using the generated and tuned data, specific to the requirement of the user. This finally helps generate a trained language model.

In another example, the computing architecture may further include an inference engine (305). The inference engine may be connected to the trained AI models through a database (306) or any appropriate file system (307). The inference engine may receive inputs from the user interface (302). It may use the AI models provided by the training engine, which may be stored in the database or accessed directly through the file system. The inference engine may then implement the data and the models for agent performance scoring using appropriately configured component (305.1). This component may be configured to define the scores that can be provided to a candidate. It may be configured according to the user desired parameters that are to be used for scoring the candidate. The inference engine may also use the call disposition component (305.2) independently or for assisting in the scoring. The agent scoring component may score agents or any participant of a call based on different segments and its elements. The Call disposition component may identify issue, cause and resolution. In an example, based on training, AI model may identify call disposition (issue, cause, resolution) and participant scoring parameters and once these elements are identified for each of the interactions it may be placed under pre-defined segments and accordingly weighted average maybe calculated based on element frequency.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for performance evaluation using a language model by a computing device, the method comprising:
training one or more data generation AI model and generating a training data for each of one or more requirements, using the trained AI data generation model and a set of predetermined parameters;
performing unsupervised training of one or more language model for a predecided domain, using the generated training data;
extracting one or more details from a transcript text of a call participant using the trained language model; and
evaluating the performance of the participant using the extracted details and the set of predetermined parameters.

2. The method as claimed in claim 1, wherein the data generation AI model is trained using a sample training data generated by a subject matter expert.

3. The method as claimed in claim 1, wherein the generated training data is labelled with one or more predefined labels. comprises:

4. The method as claimed in claim 3, wherein training of the language model comprises:
parsing the language model; and
configuring the language model using the labelled training data.

5. The method as claimed in claim 4, wherein generating a training data for each of one or more requirements comprises:
removing personal information and normalizing the training data;
labelling the normalized training data;
tokenizing the labelled data; and
fine tuning the language model using the tokenized data.

6. A system for performance evaluation using a language model comprising,
a training engine configured to:
train one or more data generation AI model and generating a training data for each of one or more requirements, using the trained AI data generation model and a set of predetermined parameters;
perform unsupervised training of one or more language model for a predecided domain, using the generated training data; and
an inference engine configured to:
extract one or more details from a transcript text of a call participant using the trained language model; and
evaluate the performance of the participant using the extracted details and the set of predetermined parameters.

7. The system as claimed in claim 6, wherein the data generation AI model is trained using a sample training data generated by a subject matter expert.

8. The system as claimed in claim 6, wherein the generated training data is labelled with one or more predefined labels.

9. The system as claimed in claim 8, wherein the training of the language model further comprises:
parsing the language model; and
configuring the language model using the labelled training data.

10. The system as claimed in claim 9, wherein the training engine is configured for generating a training data for each of one or more requirements and comprises:
a data collection and creation component configured to:
remove personal information and normalizing the training data;
label the normalized training data;
tokenize the labelled data; and
fine tune the language model using the tokenized data.

11. A non-transitory computer program product comprising a computer-readable storage media having computer-executable instructions stored thereupon, which when executed by a processor cause the processor to perform a method for performance evaluation using a language model comprising:
training one or more data generation AI model and generating a training data for each of one or more requirements, using the trained AI data generation model and a set of predetermined parameters;
performing unsupervised training of one or more language model for a predecided domain, using the generated training data;
extracting one or more details from a transcript text of a call participant using the trained language model; and
evaluating the performance of the participant using the extracted details and the set of predetermined parameters.

12. The computer program product as claimed in claim 11, wherein the data generation AI model is trained using a sample training data generated by a subject matter expert.

13. The computer program product as claimed in claim 11, wherein the generated training data is labelled with one or more predefined labels.

14. The computer program product as claimed in claim 13, wherein training of the language model comprises:
parsing the language model; and
configuring the language model using the labelled training data.

15. The computer program product as claimed in claim 14, wherein generating a training data for each of one or more requirements comprises:
removing personal information and normalizing the training data;
labelling the normalized training data;
tokenizing the labelled data; and
fine tuning the language model using the tokenized data.
